(19) United States
(12) Patent Application Publication
(10) Pub. No.: US 2012/0047010 A1
(43) Pub. Date: Feb. 23, 2012

(54) TARGETED ADVERTISING FOR STREAMING MEDIA

(76) Inventors: Michelle Dowling, Sacramento, CA (US); Dennis Dowling, Sacramento, CA (US)

(21) Appl. No.: 12/861,596

(22) Filed: Aug. 23, 2010

(51) Int. Cl. G06Q 30/00

(52) U.S. Cl. 705/14.45; 705/14.66

(57) ABSTRACT

A method for providing targeted advertising to a consumer, the method comprising the steps of: soliciting consumer preference information from a subscriber; acquiring authorization from the subscriber to collect information regarding the subscriber's consumer activity; creating a consumer preference database from the subscriber's consumer preference information; creating a consumer purchase database comprising the subscriber's consumer activity information; creating a consumer advertising profile for the subscriber based on the consumer preference and consumer purchase databases; accessing an advertising database and selecting at least one targeted advertisement based on the consumer advertising profile; detecting access by the subscriber to a streaming media environment; and delivering the targeted advertisement to the subscriber via the subscriber's streaming media environment.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files and records, but otherwise reserves all other copyright rights.

### BACKGROUND OF THE INVENTION

1. Field of the Invention

The present invention relates to software, advertising, streaming media and the Internet.

2. Description of Related Art

Advertising research has never been an exact science, and much of advertising appropriates a shotgun approach, i.e., blast away and hope to hit the target. There's an old adage among marketing firms that states, “Half of advertising works; unfortunately, no one knows which half.” Still, companies usually have at least one of four goals in mind when they advertise: to build brand awareness; to increase brand preference; to increase brand purchases; or, to maintain brand loyalty.

Television has long been considered the most effective form of advertising medium, beginning in 1941, when Bulova ran the first television advertisement in the United States during a Brooklyn Dodgers baseball game. The clockmaker featured an image of a large timepiece with the tagline, “America runs on Bulova time.”

Television engagements such as the Super Bowl are now renowned for their advertising content. In fact, approximately 50% of viewers agree that they watch that game not so much for the sporting entertainment, but for the commercial advertising. Because of its viewing popularity, Super Bowl advertisers paid as much as $3 million for a 30-second advertising segment in 2010.

With the advent of cable television, the viewing audience was spread over more television channels. Still, advertisers suddenly gained an edge with targeted advertising—they were more likely to expose qualified consumers to their product by focusing on the appeal of a particular channel or category of channels. On the down side, more channels meant audience fragmentation and fewer consumers on any given channel.

Tivo and DVRs complicate advertising even more. The general consensus among most researchers is that DVRs make consumers less likely to watch commercials, as they can simply fast forward through the advertisements. A 2008 study conducted in Great Britain, however, found that consumers are actually more likely to view television advertising if they own a DVR. This is because the average DVR owner watches 17% more programming than traditional viewers and is, thus, exposed to more advertising. Newer research shows that consumers seem to be more interested in DVR advertisements, possibly because they have selected the time and venue for delivered programming and are more likely to engage in viewing. It seems likely, then, that consumers are not completely turned off by advertisements.

Networks hoped that Internet-based streaming video sites, such as Hulu.com, would increase their advertising revenues. However, while consumers seem eager to watch television and movie programming at their convenience, advertisers are reluctant to invest even more capital into an uncertain market. Recently, Alan Wurtzel, President of NBC-Universal Research, called for a collective measure for market research. The Coalition for Media Measurement was formed in late 2009 and includes top media companies CBS and Disney and top advertiser Proctor and Gamble. Clearly, media and marketing experts are anxious for an advertising model to match existing and developing technologies.

Data is currently collected by a large number of retailers detailing specific consumer behavior. Retail club cards first made an appearance in the early 1990s. Retailers such as Costco and Sam's Club currently require a club card for admission into the store. Other retailers such as Safeway, offer reduced prices to consumers willing to participate in a consumer-loyalty program. Obviously, this technology is not so much a reward to the customer, but a means of tracking purchasing habits and behavior. In 1998, Von's attempted to use information gleaned from knowledge of a consumer's purchasing habits to rebuff a “slip and fall” accident in one of their stores. Von's attorneys suggested that the accident may have been the result of the customer's frequent alcohol purchases. In any case, many retailers appear to be interested in data mining efforts as much as simply rewarding loyal customers.

Even stores that do not use club cards can quickly access consumer activity through credit card transactions, as even a chain that does not have a consumer-loyalty card program can bring up past purchases simply by entering a consumer's credit card number. This information may be further categorized by brand and class of item purchased.

For the most part, audio and video media has always been streaming. Traditional television and radio antennas “stream” media to the user as they are watching or listening. As Michael Topic points out “streaming is the default.” What is a relatively new concept is the notion of streaming digital media.

Streaming media has become ubiquitous on the Internet. Sites such as YouTube and Hulu.com have millions of visitors daily. Advertisers have closely watched how consumers use streaming media, and many have developed marketing programs to target web users. One of the most appealing aspects of Internet-based delivery of content (at least from an advertising perspective) is that it provides an avenue for knowing information about the receiver of streamed media.

Still, Internet advertisers have come to realize that consumers don't like to give their information away so freely. Some are concerned about privacy issues, but many more would like something in return for their personal data.

Thus, there remains a need for advertising approaches tailored to take advantage of the newer channels of streaming content, but that do not make the consumers uncomfortable regarding the access to or use of information about their purchasing or viewing habits. It would be a great advantage if an advertising approach were developed that included access to all of the technologies, and did so with the willing acquiescence and participation of the consumer.

### SUMMARY OF THE INVENTION

These and other features and advantages of this invention are described in, or are apparent from, the following detailed description of various exemplary embodiments of the apparatus and methods according to this invention.

The invention provides a system and method for providing targeted advertising to a consumer, the method comprising the steps of: soliciting consumer preference information from a subscriber; acquiring authorization from the subscriber to collect information regarding the subscriber's consumer activity; creating a consumer preference database from the subscriber's consumer preference information; creating a consumer purchase database comprising the subscriber's consumer activity information; creating a consumer advertising profile for the subscriber based on the consumer preference and consumer purchase databases; accessing an advertising database and selecting at least one targeted advertisement based on the consumer advertising profile; detecting access by the subscriber to a streaming media environment; and delivering the targeted advertisement to the subscriber via the subscriber's streaming media environment.

In one embodiment, the invention further provides the step of updating the consumer advertising profile with subsequent consumer activity information.

In a preferred such embodiment, the invention further provides the step of updating the consumer advertising profile by correlating the subsequent consumer activity information to the targeted advertisement.

In a different preferred embodiment, the invention further provides subjecting the subsequent consumer activity to analysis to gauge the effectiveness of the targeted advertisement.

In another preferred embodiment, the invention further provides the step of soliciting subscriber feedback regarding said targeted advertisement.

In a still further preferred embodiment, the invention provides such a method where the subscriber feedback is used to update the consumer preference database.

In a different preferred embodiment, the invention provides such a method where the subscriber feedback is used to update the consumer advertising profile.

In a further preferred embodiment, the invention provides such a method where the updated consumer advertising profile is used to select a new targeted advertisement.

In a still different preferred embodiment, the invention provides such a method where information about the updated consumer advertising profile is communicated to a retailer.

In another preferred embodiment, the invention provides such a method where information about the updated consumer advertising profile relates to the effectiveness of the targeted advertisement.

In a still further preferred embodiment, the invention provides such a method where the consumer advertising profile is compiled by a profiling server.

In another preferred embodiment, the invention provides such a method where the profiling server comprises an algorithm.

In a different preferred embodiment, the invention provides such a method where the subscriber accesses the streaming media environment through an authorized entertainment-based web server.

In a still different preferred embodiment, the invention provides such a method where the subscriber accesses the authorized entertainment-based web server using a unique log-in.

In a further preferred embodiment, the invention provides such a method where the subscriber's consumer activity information is compiled by retailers and transmitted to the consumer purchase database.

In one preferred embodiment, the invention provides such a method where the retailers are preauthorized by the subscriber to compile the consumer activity information.

In a further preferred embodiment, the invention provides such a method where said targeted advertisement is transmitted as an electronic mail message.

In a different preferred embodiment, the invention provides such a method where said targeted advertisement is transmitted as a web page advertisement.

In a still different preferred embodiment, the invention provides such a method where said targeted advertisement is inserted into a subscriber's streamed video content.

These and other features and advantages of this invention are described in, or are apparent from, the following detailed description of various exemplary embodiments of the apparatus and methods according to this invention.

### BRIEF DESCRIPTION OF THE DRAWINGS

A more complete understanding of the present invention and the attendant features and advantages thereof may be had by reference to the following detailed description when considered in conjunction with the accompanying drawings wherein:

FIG. 1 is a diagram illustrating the embodiment of a targeted advertising model, wherein consumers are rewarded for their everyday purchases with streaming media content.

FIG. 2 is a flowchart illustrating a process for selecting a targeted advertisement based on the consumer's preferences and purchasing behavior.

### DETAILED DESCRIPTION OF THE INVENTION

The invention provides a method and system for targeting a subscribing consumer (the “subscriber”) with advertising content via streaming or downloaded media. The method includes the application of consumer-purchasing data from retailer databases, a Consolidated Subscriber Purchase Database (CSPD), a Subscriber Demographics and Preferences Database (SDPD), a profiling server, and an entertainment-based web server allowing the subscriber to access streaming or downloaded media. Retailer databases transmit subscriber information to the CSPD.

The SDPD may be created from the subscriber's consumer preference information. Consumer preference information can be extracted from a subscriber or subscribers in a number of ways. For instance, subscribers may provide demographic information and preferences to the SDPD. The CSPD and SDPD then catalogue the subscriber information, which is later accessed by the profiling server. The profiling server may select advertisements to be inserted into the subscriber's personal media stream, based on the subscriber's specific purchasing patterns or profile. The subscriber may then access the entertainment-based web server through a unique log-in and is exposed to targeted advertising.

Retailers may be preauthorized by the subscriber to compile the subscriber's consumer activity information. In this fashion, the subscribers' consumer activity data is collected through the use of a credit card, debit card, or store-loyalty card used to make everyday purchases, such as groceries and gasoline.

The subscriber's purchasing decisions and patterns can then be routed to an external server which advertisers can access for marketing activities and research. Advertisers may then provide target-specific ads to an entertainment web server where they are inserted into streaming video or audio. In some cases, the subscriber may be allowed to access exclusive entertainment content in exchange for information about consuming behavior.

The consumer advertising profile is preferably updated with subsequent consumer activity information. In this way, subsequent consumer activity information can be correlated to the targeted advertisement in ways that are highly useful to the advertiser, as various means of analysis can be applied to gauge the effectiveness of the targeted advertisement.

For example, Subscriber A shops at Wal-Mart. Subscriber A buys numerous products, just two of which are Dawn dishwashing liquid and Pepsi-Cola. At the checkout, Subscriber A either provides a rewards-type card or a specific credit card which has been linked to the retailer's database that stores subscriber-purchasing patterns.

In an exemplary implementation, Dawn, Pepsi-Cola, and Coca-Cola are participating marketers in the model. Their marketing departments receive regular reports about subscriber behavior related to their products and product categories and these companies provide target-specific advertisements to be inserted within the entertainment content. Dawn's current marketing strategy is to thank subscribers for their recent purchase and recommend other products the subscriber might be interested in. The cola companies provide advertising content similar to Dawn's, but also engage in cross-marketing solicitation; meaning Coke advertises to known Pepsi consumers, and vice versa.

When Subscriber A logs into this invention's web server to enjoy a movie later that day, she views several advertisements including the Dawn advertisement and both Pepsi and Coke commercials.

The model provides for very lucrative marketing opportunities. Desirable content such as new-release movies and popular sporting events could command advertising revenue that quickly outdistances television and other traditional advertising venues.

The embodiments described below describe techniques for targeting streaming advertisements based on subscriber-purchasing data. Subscriber-purchasing data is used to generate profiles, based on data collected from individual consumer purchasing behavior, such as that maintained by a grocery store in association with a loyalty membership card. The subscriber's profile also includes subscriber provided information such as age, gender, household size, and lifestyle preferences.

Targeted streaming advertisements are associated with one or more subscriber profile characteristic(s). Advertisements are selected from a pool of available advertisements and streamed based on the subscriber's profile and previous purchasing trends.

Subscriber feedback may be directly solicited regarding targeted advertisement, and can be used to update both the SPDP or the CSPD, as the effectiveness of the previous targeted advertisement may form a component of the updated CPSD.

In this fashion, constantly updated databases may be made available to a retailer and utilized to select new and different targeted advertisements for the subscriber.

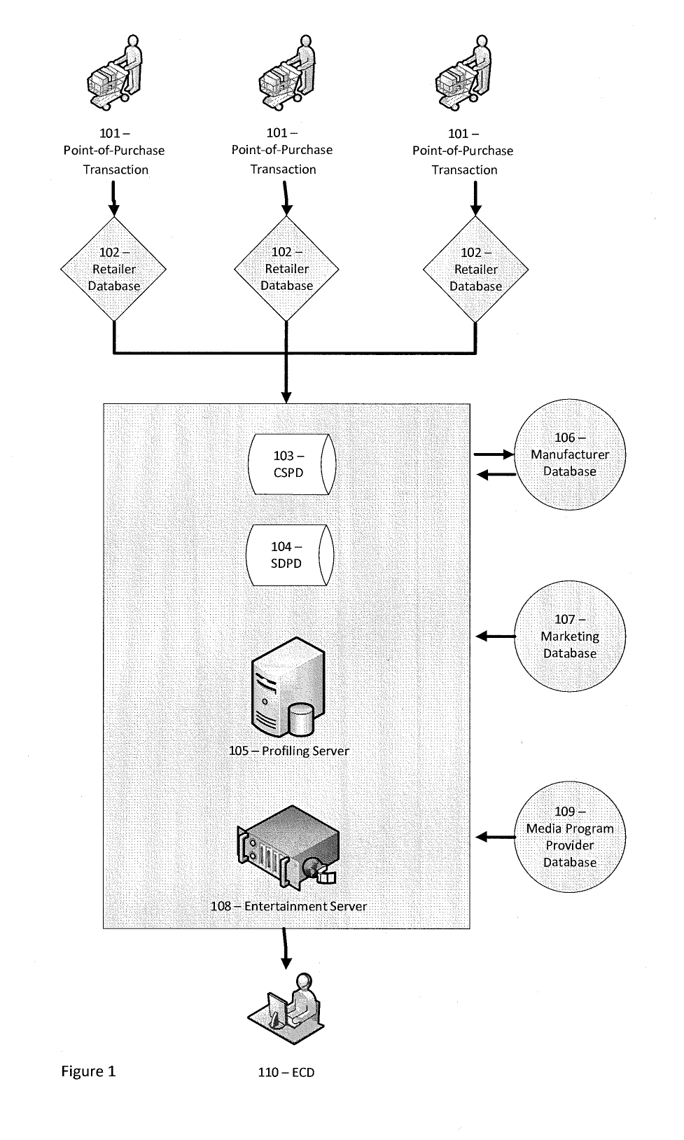

Turning now to the drawings, FIG. 1 illustrates an exemplary network environment in which targeted adverting based on consumer purchasing data may be implemented. Depicted are a point of purchase transaction 101, retailer purchase databases 102, Consolidated Subscriber Purchase Database (CSPD) 103, Subscriber Demographics and Preferences Database (SDPD) 104, profiling server 105, streaming media server 108, and Entertainment Content Device (ECD) 110. FIG. 1 further illustrates external client and vendor servers including manufacturer database 106, marketing database 107, and entertainment content provider database 109.

Point-of-purchase transaction 101 demonstrates a consumer-purchase transaction. As is known in the art, when a consumer wishes to participate in a rewards program, the consumer provides the retailer with various identifying information, such as name, address, and phone number. The consumer may provide additional demographic information to further identify their purchasing behavior. They may also provide information associated with the products of the retailer, such as purchasing preferences or purchasing behavior.

During point of purchase transaction 101, the subscriber information is entered into the retailer's computer system, and the information also may be assigned a coded dataset unique for that subscriber. The subscriber then may be issued a card with the barcode (or alternative coded dataset) printed thereon. The subscriber may also wish to forego such a reward card, opting instead to affiliate their debit or credit card with the rewards program. When the subscriber makes a purchase, the coded dataset on the card is scanned with a conventional register scanner, such as an optical scanner. The computer system of the retailer, debit, or credit card company, can thus track the subscriber's purchases.

Point-of-purchase transaction 101 also demonstrates an implied contract between the subscriber and the retailer. As is common in the art, the consumer often receives promotional items or pricing in exchange for allowing the retailer information about their shopping behavior. In an exemplary implementation of the present invention, the subscriber will receive streaming or downloaded entertainment media as a result of doing business with affiliated retailers. In exchange, the streaming media will likely contain advertising targeted to the subscriber's shopping and lifestyle behavior, though the presence of advertising is not requisite to the definition of the invention.

Point-of-purchase transaction 101 further includes purchasing data unique to that subscriber being transmitted to a retailer purchase database 102. Retailer purchase database 102 is used to describe any database utilized by retailers, creditors, banks, or any other institution that tracks consumer purchases.

Consuming information that is transmitted and stored by the retailer purchase database 102 may include, but is not limited to, information about the product or service purchased, the cost of the product, the amount the user paid, the location of the user, personal and financial information, complementary products and services purchased at the same time or on a previous shopping experience, or any other information that could be used to determine a relevant advertisement.

The information contained in retailer purchase database 102 may be automated or carried out through the use of hardware, software, firmware, or any combination thereof. The purchase information can be obtained through use of a data feed, a computer network, any combination of computer networks, or through the use of one or more servers.

Retailer purchase database 102 is representative of one or more databases that maintain consumer purchasing data. For example, a grocery store chain may gather and maintain data that describes purchases made by shoppers who carry a membership card issued by the grocery store chain. Subscriber purchase information may also be tracked by the issuer of a credit card, such as Visa or Macy's. Customer purchase databases may be maintained by any sort of retail store, service provider, creditor, or other entity that interacts with consumers and has a desire to advertise to those consumers. In addition, the embodiments of the invention are not limited to the possession of a retail loyalty card. The invention is intended to encompass the tracking of subscriber purchases through point-of-purchase transactions 101, with or without the use of a loyalty card. Furthermore, retailer loyalty database 102 may be structured in any number of ways, including as a relational database, an object-oriented database, an XML file, one or more formatted text files, and so on.

Consolidated Subscriber Purchase Database (CSPD) 103 contains a database of information gathered from any number of retailer purchase databases 102 to determine consumer-purchasing behaviors and patterns. In an exemplary implementation, a subscriber's daily purchases would be tracked and stored to show consumption patterns not previously available in present marketing models.

For example, Subscriber A stops at Safeway and, in addition to other items, purchases marshmallows, graham crackers, chocolate bars, and matches. Later that day, Subscriber A visits Camping World, where he purchases a guidebook entitled, Campgrounds in Northern California. This would pique the interest of numerous manufacturers and retailers who specialize in camping equipment, who may or may not sell products where Subscriber A normally shops. Those advertisers can then specifically target Subscriber A.

Other ways the Consolidated Subscriber Purchase Database (CSPD) 103 could be analyzed and used include, but are not limited to, targeted-advertising by manufacturers, retailers, or service provides and market research by manufacturers, retailers, or service provides. Manufactures and retailers may further use the database information to provide subscribers with product information, such as recalls and warranty information, or consumer-lifestyle information, such as recipes and coupons.

Subscriber Demographics and Preferences Database (SDPD) 104 stores consumer-supplied data and subscriber preferences. In this manner, the subscriber can sign on to an Internet site associated with the loyalty program in order to provide specific information about themselves, such as name, age, gender, and household size. Additional information might include lifestyle preferences, hobbies, and information about anticipated future purchases.

Profiling server 105 is configured to enable an analyst to indicate specific values that may be used in defining a subscriber profile. In an exemplary implementation, product categories and product vendors may be used to define a subscriber profile. The profiling server may incorporate an algorithm.

In any case, profiling server 105 processes incoming data, provided by a manufacturer database 106, which supplies product information for transmission to subscribers. This information includes, but is not limited to, advertising, trade information, product safety information, lifestyle information, or any data exchange necessary to maintain the production relationship.

Profiling server 105 further processes incoming data, provided by marketing database 107, which supplies marketing materials for transmission to subscribers. These materials may include, but are not limited to, text advertisements, image advertisements, video advertisements, audio advertisements, multimedia advertisements, interactive advertisements, and digital advertisements.

Profiling server 105 further processes outgoing data, provided to manufacturer database 106, which supplies product registration information completed by subscribers, such as warranty paperwork, rebate requests, retailer and purchase location, or any purchase data needed to service the product.

Profiling server 105 is configured to extract subscriber data from the Consolidated Subscriber Purchase Database (CSPD) 103. Profiling server 105 is also configured to extract subscriber data from the Subscriber Demographics and Preferences Database (SDPD) 104. Further, profiling server 105 is configured to extract manufacturer information from manufacturer database 106. Profiling server 105 is further configured to extract advertisements from marketing database 107. Profiling server 105 then formats the extracted data and stores it.

Profiling server 105 maintains subscriber profiles that are generated by any combination of information from Consolidated Subscriber Purchase Database (CSPD) 103, Subscriber Demographics and Preferences Database (SDPD) 104, manufacturer database 106 and marketing database 107. In an exemplary implementation, a subscriber profile is based on both product categories and/or product vendors. Example product categories include alcoholic beverages, pet supplies, gasoline purchases, dining at restaurants, and so on. Example, product vendors include Anheuser-Busch, Purina, Exxon Mobil, Pizza Hut, and so on. In the described implementation, each subscriber profile may include a targeting match based on a product category and/or a product vendor.

Using Entertainment Content Device (ECD) 110, remote users can communicate with entertainment content provider database 109, to obtain media programs (including downloaded streaming video and audio services) and to search entertainment content provider database 109 to find media programs of interest. Subscriber access to the streaming media environment may be through an authorized entertainment-based web server, which may or may not require the entry of a unique log-in.

Using Entertainment Content Device (ECD) 110, the subscriber accesses the entertainment server 108 and enters a choice for a media program. Entertainment Content Device (ECD) 110 plays the media program, and at the times identified as advertising breaks, requests advertisements from marketing database 107 using a path (e.g. URL) provided either by profiling server 105 or the entertainment server 108. Marketing database 107 streams the requested advertisement to Entertainment Content Device (ECD) 110 at the appropriate time, where it is displayed to the subscriber.

The chosen advertisements are streamed to the Entertainment Content Device (ECD) 110 and shown to the subscriber. In one embodiment, the subscriber receives advertising based on their previous purchasing behavior. In another embodiment, the subscriber receives advertising based on their profile. If no advertising is appropriate based on the subscriber's previous purchases or profile, a generic advertisement may be shown. While the targeted advertisement will most conventionally be inserted into a subscriber's streamed video content, it may also be transmitted as a web page advertisement or as an electronic mail message.

In another embodiment, the advertisements presented are selected based on any combination of subscriber purchasing data, subscriber profile, and current or previously streamed media. For example, though the subscriber may be currently streaming American Idol, based on the subscriber's recent purchase of Huggies diapers and recent stream of Blue's Clues, it can be inferred that the subscriber would still be responsive to advertisements catered to mothers with children under the age of three. Traditionally advertisers have been reluctant to position consumer-specific products, such as baby wipes, against more generic audiences.

As illustrated, Entertainment Content Device (ECD) 110, targeted advertising enables different advertisements to be rendered through different devices, even though the devices are all accessing the same website. In this manner, a subscriber using their laptop may receive a streaming video advertisement for Starbucks coffee, while another subscriber may use their iPod to stream music interspersed with an advertisement from Chevron gasoline.

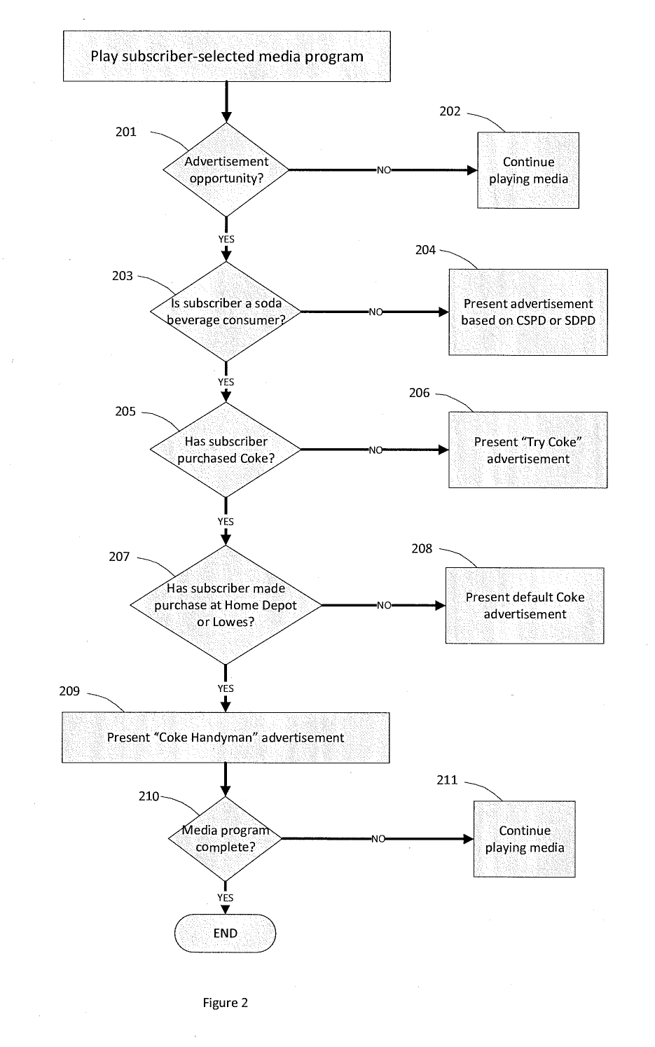

Turning now to FIG. 2, an exemplary decision process is illustrated, where advertising is delivered based on a subscriber's previous purchasing behavior. First, in step 201, profiling server 105 determines whether an advertising opportunity is present. If no advertising opportunity exists, Entertainment Content Device (ECD) 110 will continue playing media 202. If an advertising opportunity is present, profiling server 105 will assess whether the subscriber is a soda beverage consumer 203.

If the subscriber does not purchase soda products on a regular basis, profiling server 105 will default to an advertisement based on the subscriber's purchasing habits or preferences 204. If, however, the subscriber does purchase soda beverages on a regular basis, manufacturer affiliate, Coca-Cola, has asked that the subscriber view one of three different advertisements, depending on the subscriber's purchasing behavior.

At step 205, profiling server 105 determines whether the subscriber has previously purchased Coca-Cola. If the subscriber has not purchased Coke, profiling server 105 will select an advertisement entitled “Try Coke” 206, which highlights Coca-Cola products and gives the subscriber information about receiving a coupon for a free product. If the subscriber has purchased Coke products, profiling server 105 will proceed to step 207.

At step 207, profiling server 105 determines whether the subscriber has made a recent purchase at a hardware store, such as Lowe's or Home Depot. If the subscriber has not made a hardware purchase, profiling server 105 will select a default Coca-Cola advertisement 208, which highlights Coca-Cola products and varies depending on Coca-Cola's current advertising focus. For example, during the Christmas holiday season, advertisement 208 would likely display the Coca-Cola Polar Bears.

If the subscriber has made a purchase from a hardware store, profiling server 105 will proceed to step 209. Profiling server 105 presents the Coca-Cola advertisement, “Coke Handyman” 209, which shows a middle-aged man working on a number of chores around the house. His wife shows her appreciation by bringing him a Coke.

While the present invention is described with reference to the illustrations for specific applications, it should be understood that the invention is not limited to those applications. Those skilled in the art with access to invention described herein will recognize additional modifications, applications, and embodiments within the scope thereof and additional fields in which the invention would be of significant utility.

Aspects of the present invention may be implemented using hardware, software, firmware, or a combination thereof and may be implemented in one or more computer systems or other processing systems.

What is claimed is:

1. A method for providing targeted advertising to a consumer, the method comprising the steps of:
soliciting consumer preference information from a subscriber;
acquiring authorization from the subscriber to collect information regarding the subscriber's consumer activity;
creating a consumer preference database from the subscriber's consumer preference information;
creating a consumer purchase database comprising the subscriber's consumer activity information;
creating a consumer advertising profile for the subscriber based on the consumer preference and consumer purchase databases;
accessing an advertising database and selecting at least one targeted advertisement based on the consumer advertising profile;
detecting access by the subscriber to a streaming media environment; and
delivering the targeted advertisement to the subscriber via the subscriber's streaming media environment.

2. The method of claim 1, further comprising the step of updating the consumer advertising profile with subsequent consumer activity information.

3. The method of claim 2, further comprising the step of updating the consumer advertising profile comprises correlating the subsequent consumer activity information to the targeted advertisement.

4. The method of claim 3, further comprising subjecting the subsequent consumer activity to analysis to gauge the effectiveness of the targeted advertisement.

5. The method of claim 1, further comprising the step of soliciting subscriber feedback regarding said targeted advertisement.

6. The method of claim 5, wherein the subscriber feedback is used to update the consumer preference database.

7. The method of claim 6, wherein the subscriber feedback is used to update the consumer advertising profile.

8. The method of claim 7, wherein the updated consumer advertising profile is used to select a new targeted advertisement.

9. The method of claim 7, wherein information about the updated consumer advertising profile is communicated to a retailer.

10. The method of claim 8, wherein information about the updated consumer advertising profile relates to the effectiveness of the targeted advertisement.

11. The method of claim 1, wherein the consumer advertising profile is compiled by a profiling server.

12. The method of claim 11, wherein the profiling server comprises an algorithm.

13. The method of claim 1, wherein the subscriber accesses the streaming media environment through an authorized entertainment-based web server.

14. The method of claim 13, wherein the subscriber accesses the authorized entertainment-based web server using a unique log-in.

15. The method of claim 1, wherein the subscriber's consumer activity information is compiled by retailers and transmitted to the consumer purchase database.

16. The method of claim 15, wherein the retailers are preauthorized by the subscriber to compile the consumer activity information.

17. The method of claim 1, wherein said targeted advertisement is transmitted as an electronic mail message.

18. The method of claim 1, wherein said targeted advertisement is transmitted as a web page advertisement.

19. The method of claim 1, wherein said targeted advertisement is inserted into a subscriber's streamed video content.

20. A system for transmitting targeted advertising to a consumer, the system comprising
a consumer preference database created from consumer preference information solicited from a subscriber;
a consumer purchase database collected from information authorized by the subscriber and collected regarding the subscriber's consumer activity;
a consumer advertising profile for the subscriber created from the consumer preference and consumer purchase databases;
an advertising database comprising a collection of advertisements;
a consumer profiler capable of matching a targeted advertisement to a subscriber, based on the consumer advertising profile;
detection means for determining access by the subscriber to a streaming media environment; and
retrieval means for retrieving and delivering the targeted advertisement to the subscriber via the media subscriber's streaming environment.

21. The system of claim 20, wherein the consumer advertising profile is updated with subsequent consumer activity information.

22. The system of claim 21, further comprising analysis means for subjecting the subsequent consumer activity to analysis to gauge the effectiveness of the targeted advertisement.

23. The system of claim 20, further comprising a profiling server for compiling the consumer advertising profile.

24. The system of claim 23, wherein the profiling server comprises an algorithm.

25. The system of claim 20, further comprising an authorized entertainment-based web server for the subscriber can accesses the streaming media environment.

26. The system of claim 25, wherein the subscriber accesses the authorized entertainment-based web server using a unique log-in.

27. The system of claim 20, further comprising transmittal means for transmitting the subscriber's consumer activity information to the consumer purchase database.

28. The system of claim 27, wherein the subscriber's consumer activity information is compiled by authorized retailers.

29. The system of claim 28, wherein the retailers are preauthorized by the subscriber to compile the consumer activity information.

30. The system of claim 1, wherein the retrieval means transmits the targeted advertisement as an electronic mail message.

31. The system of claim 1, wherein the retrieval means transmits the targeted advertisement as a web page advertisement.

32. The system of claim 1, wherein the retrieval means transmits the targeted advertisement by inserting the targeted advertisement into a subscriber's streamed video content.
